(19) United States
(12) Patent Application Publication
(10) Pub. No.: US 2026/0180330 A1
(43) Pub. Date: Jun. 25, 2026

(54) Power Management System

(71) Applicant: Newable Power LLC, Hosuton, TX (US)

(72) Inventors: Doug Brown, Cypress, TX (US); Antonio Jose Correia Sampaio, Demerara (GY); William Fillingame, Pearland, TX (US); Youssef Assir, Sugarland, TX (US); Stephen Brown, Houston, TX (US)

(73) Assignee: Newable Power LLC, Houston, TX (US)

(21) Appl. No.: 19/428,288

(22) Filed: Dec. 21, 2025

Related U.S. Application Data
(60) Provisional application No. 63/737,379, filed on Dec. 20, 2024.

(51) Int. Cl. H02J 3/32; H02J 7/24; H02J 7/50; H02J 7/90; H02J 105/12

(52) U.S. Cl. CPC H02J 3/32; H02J 7/243; H02J 7/575; H02J 7/933; H02J 2105/12

(57) ABSTRACT

Systems and methods for supplying stable electrical power using an alternating energy storage architecture under supervisory control. Systems and methods may include at least two energy storage modules, an electrical bus configured to deliver power to a load, a motor-generator assembly coupled to the electrical bus, and a feedback distribution system configured to route a proportion of electrical power produced by the motor-generator assembly back to at least one energy storage module. An intelligent control system alternates discharge and recharge roles between the energy storage modules such that one module supplies power while another module is charged and maintains each energy storage module within a bounded state-of-charge envelope. The feedback distribution system is selectively engaged to reduce effective energy loss while maintaining stable power delivery. The systems and methods may apply to telecommunications towers, distributed power systems, microgrids, and other environments requiring reliable electrical power.

### CROSS REFERENCE TO RELATED APPLICATIONS

This application claims benefit to U.S. Provisional application Ser. No. 63/737,379, filed on Dec. 20, 2024; and this application hereby incorporates herein U.S. Nonprovisional application Ser. No. 63/737,379 as if set forth herein in its entirety.

### BACKGROUND

### 1. Field of Inventions

The invention relates generally to electrical power systems, and more specifically to systems and methods for the storage, delivery, and regulation of electrical energy using alternating energy storage modules, supervisory control logic, and controlled energy feedback pathways. Embodiments of the invention provide power to connected loads while maintaining a bounded energy state within the storage modules, and may be applied to telecommunications equipment, microgrid infrastructure, data centers, surge buffering applications, distributed industrial power systems, vehicle charging stations, or any other environment in which reliable power is required.

### 2. DESCRIPTION OF RELATED ART

Many electrical applications require a stable supply of power in environments where utility service is unavailable, unreliable, or insufficient. Examples include remote telecommunications towers, isolated communities, industrial facilities, and high-performance computing environments. Conventional solutions typically rely on a combination of generator sets, uninterruptible power supplies, and battery banks. While these systems are capable of providing power for limited intervals, they often require frequent maintenance, external fuel deliveries, or manual intervention, and may exhibit poor performance during transient load events.

Traditional battery systems degrade under repeated discharge and recharge cycles, leading to reduced storage capacity, increased heat generation, and shortened operating life. Generator-based systems may provide power, but are inefficient at low loads, subject to wear, and vulnerable to sudden changes in demand. Grid-connected facilities may rely on utility power and backup systems, but sudden surges or step-loads in data center environments often result in brownouts, interruptions, or damage to sensitive equipment. In each case, existing systems struggle to maintain equilibrium between power generation, storage, and consumption.

Furthermore, most existing systems do not operate as closed loops. They either dissipate excess energy as heat or rely on external loads to balance supply and demand. Very few systems return a portion of available energy into the storage system in a controlled manner to reduce effective losses and maintain an operating envelope. Even fewer systems alternate the roles of energy storage modules in a manner that preserves long-term capacity and enables efficient, stable operation without reliance on external systems.

There is therefore a need for a power architecture that provides a stable source of electrical energy, regulates the alternating discharge and recharge of storage modules, maintains a bounded state of charge over time, and optionally returns surplus energy through a controlled feedback pathway. Such a system should be capable of responding to sudden changes in load, supporting surge events, and operating for extended durations without external fuel or grid supply, while remaining compatible with commercial control hardware and storage technologies.

### SUMMARY

The invention provides systems and methods for the storage and delivery of electrical energy using at least two energy storage modules that alternate between discharge and recharge roles under the supervision of an intelligent control system. During operation, one module supplies power to an electrical bus while another module is recharged. When the state of charge of the discharging module approaches a lower bound, the control system switches roles, placing the former discharging module into recharge and placing another module into discharge. This alternating behavior maintains a bounded state of charge and delays the storage modules from converging toward depletion.

In preferred embodiments, a feedback pathway returns a portion of generated energy to the storage modules. The feedback pathway does not constitute a closed-cycle generator but provides a compensating return flow that reduces the effective loss of energy during repeated charge and discharge cycles. The supervisory control system determines when and to what extent the feedback pathway is active, based on load conditions, generator output, storage state of charge, and other monitored parameters. The system may operate within this bounded envelope for extended periods of time, even in remote or islanded conditions, without external intervention.

The invention may be deployed in containerized or cabinet form, used as a primary power source for remote telecommunications towers, or used as a surge buffer in data centers and high-performance computing environments. In microgrid applications, the system behaves as a local power plant, providing stable, extended periods of energy without requiring utility service. In data center applications, the system absorbs surge and pull events from the load, protecting the upstream supply from sudden changes and preserving stability. The architecture may be implemented with any suitable energy storage medium, including batteries, capacitors, flywheels, hydraulic storage, or hybrid combinations thereof.

In all embodiments, the intelligent control system monitors the state of the energy storage modules, bus conditions, generator output, environmental parameters, and load demand. The control system maintains stable operation, performs switching without interrupting power delivery, and supervises safety and fault response. The invention may optionally include tertiary storage systems, which remain offline under normal conditions and are activated only when required to supplement the primary storage banks. The invention therefore provides a resilient, efficient power platform suitable for a wide range of applications.

### DESCRIPTION OF THE DRAWINGS

The accompanying drawings illustrate embodiments of the invention and form a part of the present specification. The drawings are provided for purposes of illustration only and are not intended to limit the scope of the invention. Elements shown in the drawings may be exaggerated for clarity, and similar reference numerals may be used to identify corresponding elements in different views.

FIG. 1 is a schematic top plan view of a containerized power system according to an embodiment of the invention. The power system of FIG. 1 has a main power switch (100) for turning on, off, or switching to external power. The figure illustrates an enclosure, such as a prefabricated steel container (1100), within which two energy storage modules, electrical storage tower 1 (430) and electrical storage tower 2 (440) are mounted in the container (1100). A motor-generator assembly (700) is centrally located along the longitudinal axis of the enclosure as represented by an induction motor (710) and a synchronous generator (720), and electrical racks containing inverters, as represented in FIG. 1 as a first inverter (450) and a second inverter (460), chargers as shown in FIG. 1 as a first charging system (410) and a second charging system (420), breakers (600), and control equipment (300) are mounted along a wall. A bus bar (200) is also shown, which contains a first bus bar (210) and a second bus bar (220) (not shown). FIG. 1 also includes a power feedback system (900) for returning a portion of the power generated by the system to the first charging system (410) and the second charging system (420). The remainder of the power generated by the power system is to an external load through output power source 1000)

FIG. 2 is a single-line electrical diagram illustrating the relationship between a first energy storage module (430) and a second energy storage module (440), a first electrical bus (210) and a second electrical bus (220), a generator (230), and an external load (240). The diagram shows the first electrical bus (210) delivering power to the external load, the second electrical bus (220) providing charging and generation pathways or selective shutoff, and a feedback distribution path (900) returning a portion of power from the power system output to the energy storage modules through a first charging system (410) and a second charging system (420

FIG. 3 is a block diagram of the intelligent control system. The figure illustrates input signals received from the energy storage modules, generator, load, and environmental sensors. Control outputs to inverters, chargers, breakers, excitation windings, and feedback routing devices are shown.

In the illustrated embodiment, feedback signals including voltage, current, speed, load, temperature, and environmental conditions are routed through a feedback distribution system (FDS), which provides signal conditioning, routing, and isolation prior to delivery to the intelligent control system. The intelligent control system processes the received feedback signals and generates corresponding control outputs to coordinate operation of the electrical energy management and storage system, the motor-generator set system, and associated switching and routing components.

Optional communication links to external supervisory systems may be indicated.

FIGS. 4A, 4B, and 4C illustrate alternating discharge and recharge intervals of the energy storage modules during various states of operation.

FIG. 4A depicts a start-up cycle (200), in which an initial energy storage module is configured to discharge to establish system operation while the other energy storage module is maintained in a non-discharging state.

FIG. 4B illustrates a subsequent operating state following a switching event, in which the first energy storage module transitions to a charging state and the second energy storage module transitions to a discharging state.

FIG. 4C illustrates a further operating state in which the discharge and recharge roles of the energy storage modules are alternated. The relative durations of the discharge and recharge intervals are shown schematically, with recharge intervals being shorter than discharge intervals in order to maintain a bounded state of charge.

Not all drawings are required in every embodiment. The figures collectively illustrate representative implementations of the invention, which may be adapted for different environments, container sizes, storage media, or control systems. Additional views, detailed drawings, and alternative layouts may be employed without departing from the spirit of the invention.

Not all drawings are required in every embodiment. The figures collectively illustrate representative implementations of the invention, which may be adapted for different environments, container sizes, storage media, or control systems. Additional views, detailed drawings, and alternative layouts may be employed without departing from the spirit of the invention.

### DETAILED DESCRIPTION

### 1. Introduction

A detailed description will now be provided. The purpose of this detailed description, which includes the drawings, is to satisfy the statutory requirements of 35 U.S.C. § 112. For example, the detailed description includes a description of the inventions disclosed herein and sufficient information that would enable a person having ordinary skill in the art to make and use the inventions. In the figures, like elements are generally indicated by like reference numerals regardless of the view or figure in which the elements appear. The figures are intended to assist with the description and to provide a visual representation of certain aspects of the subject matter described herein. The figures are not all necessarily drawn to scale, nor do they show all the structural details of the systems, nor do they limit the scope of the disclosure herein.

### 2. Specific Embodiments in the Drawings

The invention described herein is a unified platform for power generation, storage, and control that operates consistently across multiple environments. Although the preceding sections describe specific embodiments in cell towers, data centers, electric vehicle charging facilities, and microgrid installations, the architecture underpinning each embodiment remains fundamentally the same. Each use-case expresses a different deployment of a common technology. This engine comprises at least two energy storage modules operated in alternating discharge and recharge cycles, a motor-generator assembly to provide mechanical and electrical power, a feedback distribution path that recirculates a portion of the generator output to storage, and an intelligent control system that maintains a bounded state-of-charge envelope for the energy storage modules. The interaction of these elements within a closed boundary yields a resilient, efficient, self-regulating power platform.

At the core of the invention is the observation that meaningful efficiency and runtime extension arise not from the individual components themselves, but from the constraints imposed by operating them together: energy storage modules are never allowed to run down toward depletion, generator output is not wasted at partial or light loading, and energy returning from generator operation is recaptured through a feedback pathway rather than being dissipated as heat. The resulting system exhibits emergent behavior: storage life is extended, generator fall-off is reduced, and the entire system continues to operate in a steady and predictable cycling pattern. The bounded state-of-charge envelope, achieved through alternating discharge and recharge cycles, prevents deep cycling and thermal stress, thereby prolonging equipment life and reducing maintenance.

Another unifying feature is the supervisory role of the control system. Regardless of the deployment domain, the intelligent control system measures storage states, regulates switching events, modulates generator excitation, engages or bypasses the feedback path, routes power to internal and external buses, and provides telemetry and alarms. This supervisory layer transforms the invention from a power supply into a coordinating platform: it may assume responsibility for generator behavior, renewable integration, load sharing, safety, and grid synchronization. In some embodiments, it becomes “the box” that mediates all energy flow into and out of the power system, enabling the operator to treat the invention as the central controlling node in a network of power resources.

The system is designed to be physically self-contained, environmentally hardened, and logistically simple. A containerized enclosure may be transported by truck, crane, rail, or helicopter and set in place with minimal construction. This makes the system particularly well suited for remote installations, rapid deployment, and environments where utility infrastructure is unavailable, unreliable, or cost-prohibitive. The same enclosure and internal layout may be used at a cell tower site, a charging station, a campus microgrid, or at the edge of a data center. Only external connections change; the internal operating principles remain constant.

The business logic is not ancillary to the invention—it arises from the same constraints that govern the technical performance. Alternating discharge protects the storage media from deep cycling, which reduces replacement cost. Feedback recaptures generator output that would otherwise be lost, which reduces fuel expense. Running at high efficiency reduces maintenance visits. Containerization reduces installation costs and accelerates deployment. Together, these create a compelling technology platform that can be deployed in different markets without redesigning the underlying engine.

The invention may be expressed as a system, a method, a controller, a computer-readable medium, or a containerized apparatus. Each embodiment may be claimed as a dependent variation that incorporates the core alternating architecture, feedback path, and supervisory control, applied to a particular environment. In this way, the invention is both the technical innovation and the configuration through which the business value is realized. Although many embodiments are described, they are tied together by a single inventive concept: a closed-loop alternating energy storage architecture operating under supervisory control to maintain a bounded state-of-charge envelope and to produce unexpected efficiency and resiliency in varied power applications.

The following description sets forth illustrative embodiments of the invention in sufficient detail to enable a person of ordinary skill in the art to make and use the subject matter. The specific arrangements described are for exemplary purposes only, and variations in materials, dimensions, control algorithms, energy storage media, and load types may be made without departing from the scope of the invention.

### 623.1 Overview of System Architecture

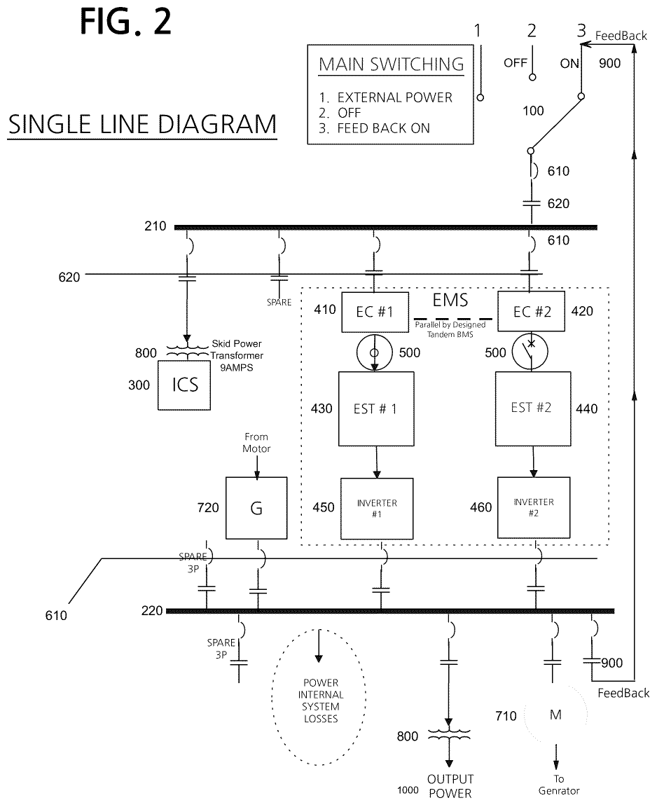

As shown in FIGS. 2 and 4A-4C, the invention provides a power generation and storage system in which at least two energy storage modules (430, 440) alternately discharge and recharge through a motor-generator assembly (230) under supervisory control (300).

In general, the invention provides a power generation and storage system in which at least two energy storage modules (430, 440) alternately discharge and recharge through a motor-generator assembly (230). The system includes an alternating discharge architecture and a controlled feedback distribution path (900). This architecture maintains a bounded state-of-charge envelope for each energy storage module, enabling extended runtimes, improved energy capture efficiency, and reduced degradation of storage media.

The system is enclosed within a structural housing (100). In preferred embodiments, the housing is a transportable container sized to fit common logistics form factors such as 20-foot or 40-foot ISO containers, although fixed-site housings, skid-mounted structures, or chassis-mounted enclosures may also be used. Electrical equipment including inverters (250), charging systems (410, 420), power conversion racks, breaker panels, and control electronics associated with the supervisory controller (300) are mounted along a rear or side wall of the enclosure. Energy storage modules (430, 440) are positioned along opposite sides of the enclosure, and the motor-generator assembly (230) is centrally located. This configuration provides balanced weight distribution, short electrical pathways, and a defined airflow channel for thermal management.

### 3.2 Alternating Discharge and Recharge Operation

During operation, a first energy storage module (430) discharges through an inverter (250) and supplies power to an external load (240) and, in some embodiments, to the generator (230). The generator (230) converts a portion of that power into mechanical energy, which is used to drive the rotor and maintain voltage and frequency on an electrical bus (210). Excess electrical energy produced by the generator is returned through the feedback distribution path (900) to charge a second energy storage module (440) via an associated charging system (420).

A supervisory controller (300) monitors the state of charge of each energy storage module (430, 440). When the discharging module approaches a lower state-of-charge threshold, control logic initiates a switching event in which the discharging module transitions to charging via a charging system (410) and the charging module transitions to discharging. Switching behavior is coordinated such that discharge intervals are longer than recharge intervals, causing the state of charge of each module to oscillate within a bounded region. This approach maintains readiness, prevents deep depletion, and limits thermal stress and degradation.

The state-of-charge envelope is defined by upper and lower bounds, including an upper limit SOC_max and a lower limit SOC_min. These values may vary depending on battery chemistry, temperature, load profile, and environmental conditions. In some embodiments, SOC_max may range from approximately 80 to 95 percent and SOC_min may range from approximately 20 to 40 percent, although other values may be used depending on application requirements. Switching events may be triggered when the active module approaches SOC_min and the inactive module approaches SOC_max, or based on other monitored criteria including power demand, temperature, voltage, or generator performance.

### 3.3 Feedback Distribution Path

A distinguishing feature of the invention is the feedback distribution path (900), which routes a portion of the generator output from the electrical bus (220) back to the energy storage module designated for charging (430 or 440). Unlike open-architecture systems in which multiple sources and sinks interact through unconstrained balancing, the feedback distribution path (900) forms part of a closed system boundary. Power circulating within the feedback loop may provide benefits including reduction in state-of-charge falloff in the active module, increased effective runtime, smoothing of power delivery under changing load conditions, and improved capture of transient generator output.

Generator efficiency may vary during startup, ramping, and steady-state operation. In the illustrated embodiments, generator output that would otherwise be dissipated as thermal loss may be captured and returned to storage through the feedback distribution path (900). The feedback distribution path is selectively engaged by switching elements under control of the supervisory controller (300). Feedback may be dynamically modulated or bypassed during fault conditions, startup, or high-demand operation.

### 3.4 Startup Operation

Startup operation involves a sequence of coordinated actions executed under the control of the supervisory controller (300). Upon initiation, control electronics are activated and the supervisory controller (300) begins sensing voltages, currents, temperatures, and environmental conditions throughout the system. Based on sensed conditions, the supervisory controller selects a primary energy storage module (430 or 440) designated as the initial discharge source.

Following selection of the primary storage module, discharge is initiated from that module through an inverter (250) to energize an electrical bus (210) and establish initial voltage and frequency conditions. As inverter output reaches minimum operating parameters, the motor-generator assembly (230) is engaged. Generator speed is increased under control of excitation and applied load, and generator output is synchronized with inverter output. Voltage, frequency, and phase alignment are managed to support stable operation.

As generator output ramps, power is delivered to support the connected load (240) and, where applicable, to initiate charging of the inactive energy storage module through the feedback distribution path (900) and an associated charging system (410 or 420). Once synchronization and ramping are complete, the system transitions into steady-state alternating discharge and recharge operation as illustrated in FIGS. 4B and 4C. Throughout startup, safety checks are continuously enforced, and startup may be inhibited or aborted if monitored conditions fall outside allowable operating ranges, including state-of-charge limits, temperature thresholds, grounding integrity, or other system constraints.

### 3.5 Steady-State Operation

In steady-state operation, the system alternates between discharge and recharge of the energy storage modules (430, 440) at periodic intervals. In a representative embodiment, a first energy storage module (430) supplies power by discharging through an inverter (250) while a second energy storage module (440) is simultaneously recharged via an associated charging system (420). After a predetermined interval, the roles of the modules are reversed such that the previously discharging module transitions into a recharge state and the previously charging module transitions into discharge. This alternating behavior continues cyclically during steady-state operation, as illustrated in FIGS. 4B and 4C.

The duration of discharge intervals and recharge intervals is controlled by the supervisory controller (300). In preferred embodiments, discharge intervals are longer than recharge intervals, resulting in a gradual net replenishment of energy within the storage system. This timing relationship allows the system to maintain both energy storage modules (430, 440) within a bounded state-of-charge envelope while continuously supplying power to the connected load (240).

During steady-state operation, the supervisory controller (300) monitors the state of charge of each energy storage module (430, 440) and compares measured values against predefined upper and lower thresholds. A switching event may be initiated when the state of charge of the discharging module approaches a lower threshold or when the state of charge of the charging module approaches an upper threshold. Switching events may also be influenced by load demand, generator performance, temperature conditions, or other monitored parameters. Switching between modules is coordinated such that power delivery to the external load (240) is not interrupted.

The bounded state-of-charge envelope is defined by a minimum state-of-charge limit SOC_min and a maximum state-of-charge limit SOC_max. The system is configured such that the state of charge of each energy storage module (430, 440) oscillates within this envelope over time. The supervisory controller (300) enforces this envelope to prevent deep discharge, excessive charge, thermal stress, and accelerated degradation of the energy storage modules.

Throughout steady-state operation, generator output from the motor-generator assembly (230) contributes to maintaining voltage and frequency stability on the electrical bus (210). A portion of the generator output may be routed through the feedback distribution path (900) to recharge the inactive energy storage module. Engagement of the feedback distribution path (900) is controlled by the supervisory controller (300) and may be dynamically adjusted in response to operating conditions, including load demand, generator output, and storage state-of-charge conditions.

### 3.6 Supplemental Tertiary Storage

In some embodiments, supplemental tertiary storage devices (500) are provided to absorb surplus energy or to extend runtime beyond that provided by the alternating energy storage modules (430, 440) alone. Such tertiary storage devices (500) may be used to capture excess energy during operation, provide additional buffering during transient conditions, or support extended operation during refueling, maintenance, or abnormal operating conditions. The inclusion of tertiary storage is optional and is not required for normal operation of the alternating discharge architecture.

Examples of tertiary storage devices include flywheels, hydraulic accumulators, and capacitive banks. These devices may be selected based on application requirements, response time, energy density, environmental constraints, or lifecycle considerations. The tertiary storage devices (500) are configured to connect to the electrical bus (210) through appropriate power conversion and switching components and are coordinated by the supervisory controller (300) to support stable system behavior.

In representative embodiments, tertiary storage devices (500) remain offline during normal alternating discharge and recharge operations and are engaged only when specific conditions are detected. Such conditions may include unexpected load surges, loss or degradation of generator performance, extension of runtime during refueling or maintenance, or other operational scenarios in which supplemental energy buffering is advantageous. When engaged, the tertiary storage devices (500) operate in coordination with the primary energy storage modules (430, 440) to maintain power delivery and system stability.

In alternate embodiments, such as microgrid or data center deployments, tertiary storage may be unnecessary because upstream systems provide equivalent stabilizing capacity. The invention is compatible with both approaches.

### 3.7 Intelligent Control System

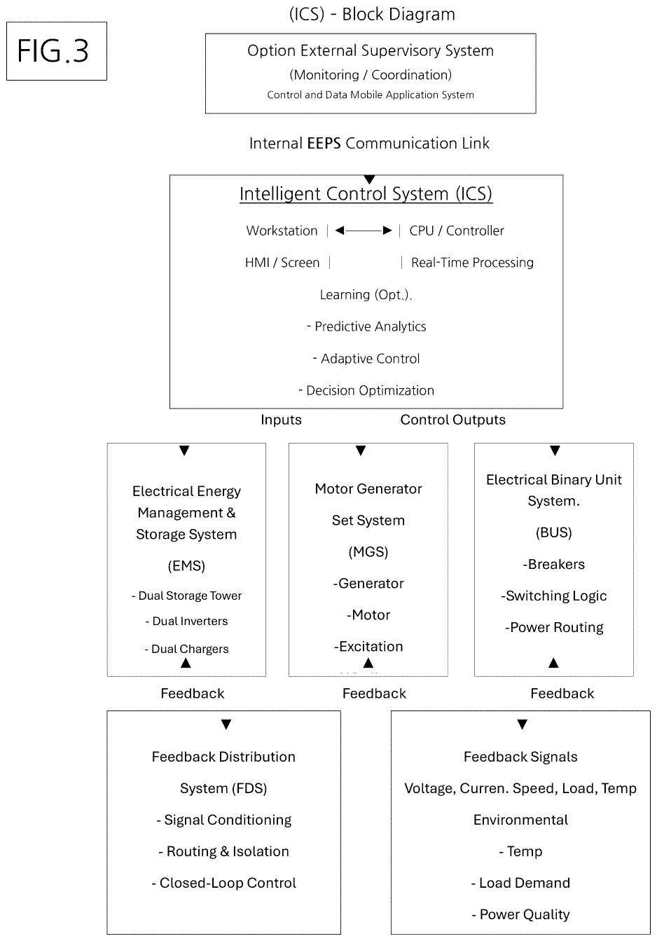

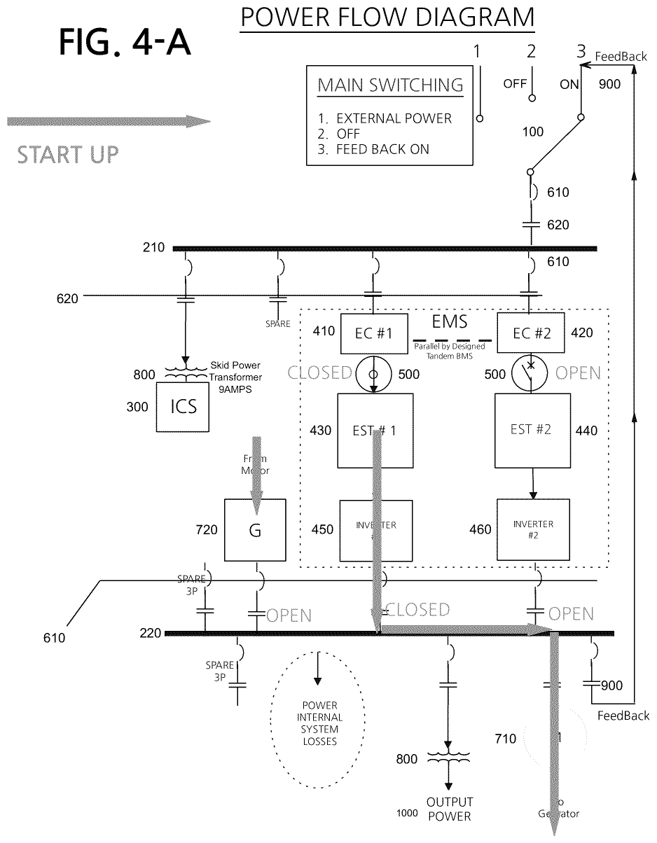

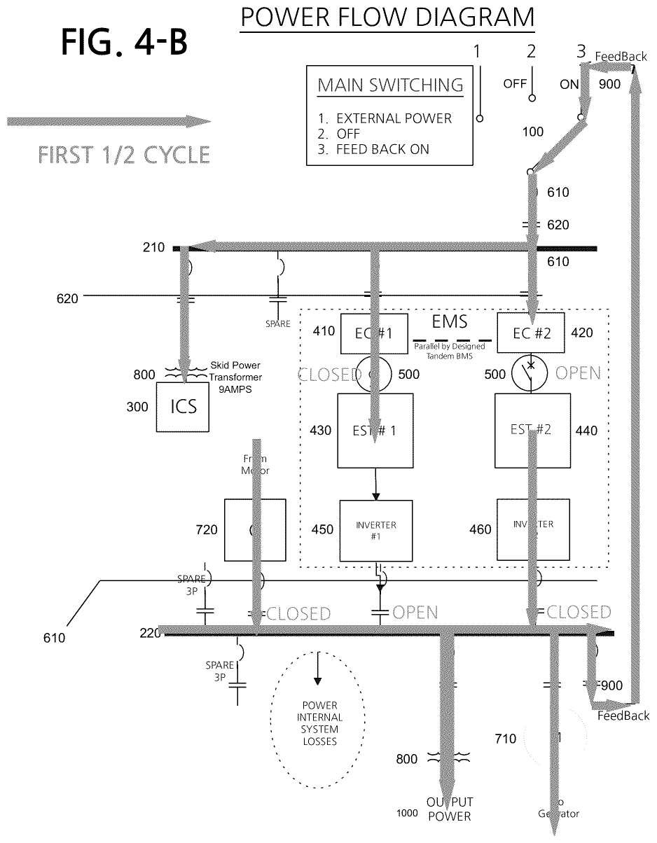

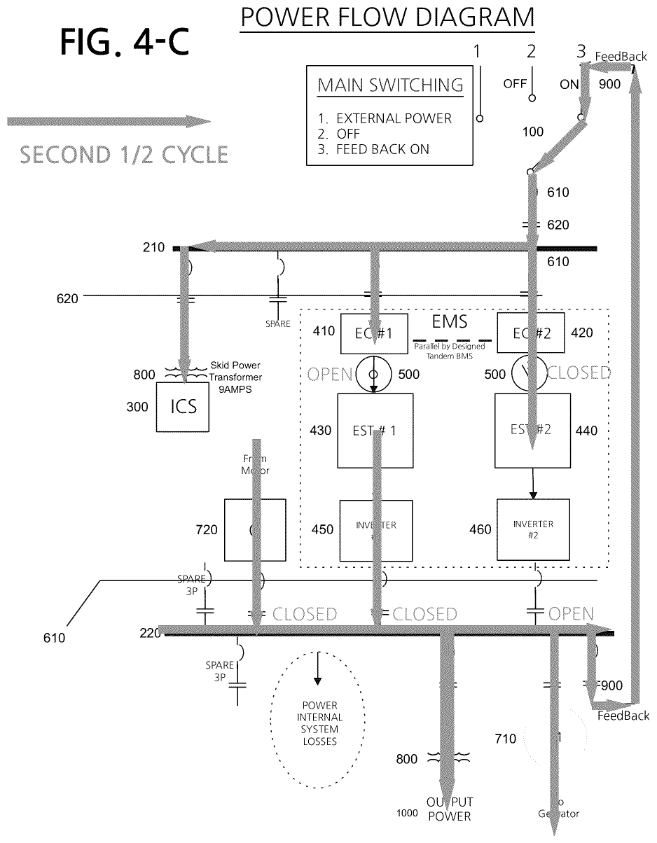

As illustrated in FIG. 3, the system includes a supervisory control platform referred to herein as an Intelligent Control System (ICS) (300). The ICS (300) is configured to monitor, control, and coordinate operation of the alternating energy storage modules (430, 440), the motor-generator assembly (230), associated power-conversion components including inverters (250) and charging systems, switching devices, environmental subsystems, safety subsystems, and any optional renewable, tertiary, or external energy sources. The ICS (300) operates as the central supervisory authority governing energy flow, switching behavior, safety enforcement, and continuity of power delivery throughout the system.

The ICS (300) may be implemented using industrial controllers, programmable logic controllers, microcontrollers, embedded controllers, industrial computers, or combinations thereof. The ICS may execute deterministic control logic, state-based algorithms, model-based control strategies, optimization routines, and machine-learning-assisted methods, either individually or in combination.

The ICS (300) acquires input data from a plurality of sensors and monitored electrical nodes distributed throughout the system. Monitored inputs may include the state of charge (SOC), voltage, current, impedance, temperature, and inferred health characteristics of each energy storage module (430, 440). The ICS may further monitor bus-level electrical quantities including voltage, frequency, phase, harmonic content, real power, reactive power, and power factor at one or more electrical bus interfaces (210, 220). Generator-related inputs may include generator speed, excitation current, torque, output power, winding temperature, and vibration signatures. Additional monitored parameters may include the open or closed status of breakers, relays, contactors, and switching devices, as well as current and voltage measured at breaker terminals or protected lines.

The ICS (300) may also receive environmental and safety-related input signals including ambient enclosure temperature, localized thermal gradients, enclosure pressure, humidity, smoke concentration, hazardous gas indicators, and enclosure access or intrusion status. In representative embodiments, thermal sensing is spatially distributed across multiple physical zones including battery enclosures, inverter cabinets, cable trays, contactor and breaker assemblies, and the generator compartment, such that both ambient conditions and localized heating events are detected.

Based on these monitored inputs, the ICS (300) generates control outputs that actuate a plurality of controlled elements. Such outputs may include commands to alternate the charge and discharge roles of the energy storage modules (430, 440); commands to open or close breakers, contactors, or relays; inverter setpoints governing output voltage, frequency, phase, current limits, and power limits; charger setpoints governing charging current and voltage for the inactive energy storage module; and generator setpoints including excitation control, speed control, or operating constraints. The ICS (300) may further control engagement, modulation, or bypass of the feedback distribution path (900) that returns a portion of generator output or surplus energy to one or more energy storage modules.

In operation, the ICS (300) enforces a bounded operating envelope for each energy storage module (430, 440) and coordinates switching events such that delivery of power to the external load (240) is continuous. Switching decisions may be computed based on combinations of SOC thresholds, predicted load demand, generator response characteristics, environmental conditions, thermal margins, maintenance states, and safety constraints. In some embodiments, the ICS implements a hierarchical control architecture in which outer-loop safety constraints override optimization or performance-based logic. Such outer-loop constraints may include detection of hazardous gas concentration, smoke, abnormal vibration, thermal runaway precursors, enclosure access violations, grounding faults, or other abnormal conditions requiring immediate protective action. Inner-loop control functions regulate inverter behavior, generator excitation, electrical bus regulation, and switching of contactors and breakers, subject to enforcement of the outer-loop constraints.

The ICS (300) may evaluate and apply control relationships including, without limitation, the expression

$$Δ SOC = SOC\_max - SOC\_min ,$$

which represents a permitted state-of-charge operating range for an energy storage module. The ICS may further evaluate a feedback-power relationship expressed as

$$P\_fb = k \cdot P\_gen ,$$

where P_fb represents feedback power routed through the feedback distribution path (900), P_gen represents generator output power from the motor-generator assembly (230), and k is a proportional constant determined by the selected control strategy. Switching intervals may be determined according to a function expressed as

$$T\_switch = f ( SOC\_a , SOC\_b , P\_wanted , T\_module ) ,$$

where T_switch represents a switching interval, SOC_a and SOC_b represent states of charge of respective energy storage modules, P_wanted represents external load demand, and T_module represents module temperature or other module-specific parameters. Constants, coefficients, thresholds, and functional relationships associated with these expressions may vary by implementation and need not be explicitly disclosed to enable practice of the invention.

The ICS (300) may process raw sensor data to compute diagnostic features including rates of change of temperature or voltage, impedance drift metrics, harmonic signatures, current imbalance indicators, breaker-contact resistance proxies, duty-cycle histories, and event sequences. The ICS may compare computed features to baselines, thresholds, statistical bounds, or learned profiles to detect anomalies. Upon detection of anomalous conditions, the ICS may initiate alarms, modify operating envelopes, adjust switching timing, isolate affected subsystems, initiate derating actions, or generate maintenance recommendations.

In certain embodiments, the ICS (300) incorporates machine-learning models to enhance predictive accuracy, reliability, or safety. Machine-learning-assisted methods may be used to predict load demand, forecast renewable input, estimate internal states of energy storage modules including SOC and health parameters, detect incipient faults, select switching times and control setpoints, and determine derating actions. Machine-learning models may be executed locally, remotely, or in a hybrid configuration. In all embodiments, the ICS retains overriding authority to enforce safety constraints and may reject or bypass any machine-learning recommendation to ensure compliance, stability, and continuous power delivery.

### 3.8 Safety and Fault Handling

The system employs sensors and supervisory logic to detect and respond to abnormal operating conditions in order to maintain stability and, when feasible, continuity of power delivery. The Intelligent Control System (300) continuously monitors electrical, mechanical, thermal, and environmental parameters and evaluates those parameters against predefined operating limits, safety thresholds, and fault conditions. Upon detection of an abnormal condition, the system initiates protective actions designed to preserve equipment integrity, maintain essential load support, and transition the system into a safe operating state.

Representative fault conditions monitored by the system include over-current conditions, over-temperature conditions, under-frequency conditions, loss of neutral or ground, enclosure intrusion, and generator stall. Additional abnormal conditions may include voltage excursions, abnormal vibration, communication failures, sensor faults, or combinations thereof.

When a fault condition is detected, the system may initiate one or more responsive actions depending on the nature and severity of the fault. Such actions may include initiating a controlled shutdown sequence, bypassing the feedback distribution path (900), isolating one or more energy storage modules (430, 440), rerouting power through alternate pathways, shedding non-essential loads, derating system output, or placing the system into a protective operating mode. The supervisory controller (300) may also generate alarms, warnings, or notifications and transmit such information to local or remote supervisory personnel.

Safety pathways are configured to allow the system to enter a safe state while maintaining essential load support when feasible. In certain fault scenarios, the system prioritizes continuity of power delivery to critical loads while isolating affected subsystems. In other scenarios, the system may execute a staged shutdown to prevent equipment damage or hazardous conditions. The supervisory controller (300) coordinates these actions to prevent cascading failures and maintain orderly system behavior.

In some embodiments, safety handling includes extension of runtime during refueling or maintenance operations by dynamically adjusting operating parameters, bypassing non-essential subsystems, or engaging alternate energy sources. In all embodiments, safety logic operates with priority over optimization routines, predictive algorithms, or machine-learning-assisted control functions, and protective actions are executed automatically under control of the supervisory controller (300) without requiring manual intervention.

### 4. DETAILED DESCRIPTION OF THE EMBODIMENTS

The following description sets forth illustrative embodiments of the invention in sufficient detail to enable a person of ordinary skill in the art to make and use the subject matter. The specific arrangements described are for exemplary purposes only, and variations in materials, dimensions, control algorithms, energy storage media, and load types may be made without departing from the scope of the invention.

### 4.1 Overview of System Architecture

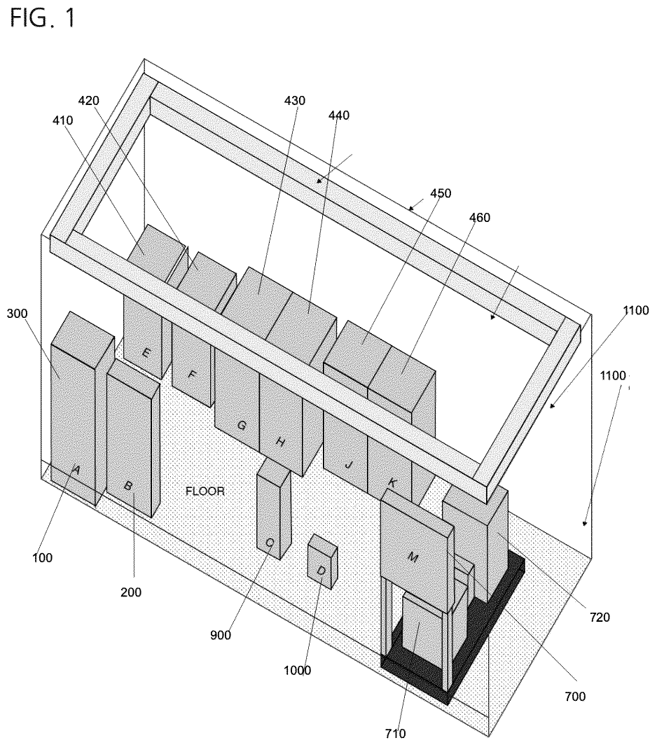

As shown in FIGS. 1-4, the invention provides a power generation and storage system in which at least two energy storage modules (430, 440) alternately discharge and recharge through a motor-generator assembly (230) under supervisory control (300). The system includes an alternating discharge architecture and a controlled feedback distribution path (900). This architecture maintains a bounded state-of-charge envelope for each energy storage module, enabling extended runtimes, improved energy capture efficiency, and reduced degradation of storage media.

The system is enclosed within a structural housing (100). In preferred embodiments, the housing is a transportable container sized to fit common logistics form factors such as 20-foot or 40-foot ISO containers, although fixed-site housings, skid-mounted structures, or chassis-mounted enclosures may also be used. Electrical equipment including inverters (250), charging systems (410, 420), power-conversion racks, breaker panels, and control electronics associated with the Intelligent Control System (300) are mounted along a rear or side wall of the enclosure. Energy storage modules (430, 440) are positioned along opposite sides of the enclosure, and the motor-generator assembly (230) is centrally located. This configuration provides balanced weight distribution, short electrical pathways, and a defined airflow channel for thermal management.

### 4.2 Alternating Discharge and Recharge Operation

During operation, a first energy storage module (430) discharges through an inverter (250) and supplies power to an external load (240) and, in some embodiments, to the motor-generator assembly (230). The motor-generator assembly (230) converts a portion of that power into mechanical energy, which is used to drive the rotor and maintain voltage and frequency on an electrical bus (210). Excess electrical energy produced by the motor-generator assembly is returned through the feedback distribution path (900) to charge a second energy storage module (440) via an associated charging system (420).

A supervisory controller (300) monitors the state of charge of each energy storage module (430, 440). When the discharging module approaches a lower state-of-charge threshold, control logic initiates a switching event in which the discharging module transitions to charging and the charging module transitions to discharging. Switching behavior is coordinated such that discharge intervals are longer than recharge intervals, causing the state of charge of each module to oscillate within a bounded region. This approach maintains readiness, prevents deep depletion, and limits thermal stress and degradation.

The state-of-charge envelope is defined by upper and lower bounds, including an upper limit SOC_max and a lower limit SOC_min. These values may vary depending on battery chemistry, temperature, load profile, and environmental conditions. In some embodiments, SOC_max may range from approximately 80 to 95 percent and SOC_min may range from approximately 20 to 40 percent, although other values may be used depending on application requirements. Switching events may be triggered when the active module approaches SOC_min and the inactive module approaches SOC_max, or based on other monitored criteria including power demand, temperature, voltage, or motor-generator performance.

### 4.3 Feedback Distribution Path

A distinguishing feature of the invention is the feedback distribution path (900), which routes a portion of the output of the motor-generator assembly (230) back to the energy storage module designated for charging (430 or 440). Unlike open-architecture systems in which multiple sources and sinks interact through unconstrained balancing, the feedback distribution path (900) forms part of a closed system boundary. Power circulating within the feedback loop may provide benefits including reduction in state-of-charge falloff in the active module, increased effective runtime, smoothing of power delivery under changing load conditions, and improved capture of transient motor-generator output.

The system leverages the fact that motor-generator efficiency may vary during startup, ramping, and steady-state operation. In the illustrated embodiments, output that would otherwise be dissipated as thermal loss may be captured and returned to storage through the feedback distribution path (900). The feedback distribution path (900) is selectively engaged by switching elements under control of the supervisory controller (300). Feedback may be dynamically modulated or bypassed during fault conditions, startup, or high-demand operation.

### 4A. Cell Tower Form Embodiment

### 4A.1 Overview

In a preferred embodiment, the invention is implemented as a containerized power system for telecommunications towers, including cellular communication towers deployed in remote or semi-remote areas. This embodiment is illustrated schematically in FIGS. 1, 2, 4A-4C, and 7, in which the alternating energy storage architecture, motor-generator assembly (230), feedback distribution path (900), and supervisory control system (300) are disposed within a transportable enclosure (100).

The system is configured to provide sustained AC power output suitable for telecommunications infrastructure. In representative embodiments, the system supplies between approximately 15 kW and 30 kW of AC output power to telecommunications equipment (240), although higher or lower capacities may be used depending on deployment requirements. Runtime is provided using two or more energy storage modules (430, 440) operated in alternating discharge and recharge cycles, supplemented by operation of the motor-generator assembly (230) and coordinated engagement of the feedback distribution path (900) to maintain continuous power delivery.

In some deployments, the system may be used as a replacement for, or augmentation to, conventional backup power systems used at telecommunications towers, including diesel generator systems and battery-based uninterruptible power supply (UPS) systems. The closed-loop alternating energy storage architecture allows the system to maintain bounded state-of-charge operation while supporting extended runtime without reliance on oversized generators or large battery banks.

The system may be implemented in a containerized or cabinet-based form factor suitable for outdoor installation proximately to a telecommunications tower. The enclosure (100) may include environmental protection, thermal management, and security features appropriate for remote deployment. Power conversion components, energy storage modules (430, 440), the motor-generator assembly (230), and the Intelligent Control System (300) are integrated within the enclosure to provide a self-contained power solution.

In operation, the supervisory controller (300) coordinates alternating discharge and recharge of the energy storage modules (430, 440), manages generator engagement as required, and regulates the feedback distribution path (900) to maintain continuous AC output power. The system adapts dynamically to changing load conditions at the tower, including peak transmission periods and low-load idle states, while maintaining stable operation.

### 4A.2 Operational Characteristics and Advantages

The cell tower embodiment leverages the alternating energy storage architecture to provide continuous power delivery while limiting stress on individual energy storage modules (430, 440). By operating within a bounded state-of-charge envelope, the system avoids deep discharge and overcharge conditions that may shorten storage life in conventional systems.

The supervisory controller (300) monitors system parameters including load demand, state of charge, generator operating status, and environmental conditions, and adjusts operating modes accordingly. The feedback distribution path (900) enables a portion of generator output to be recaptured and redistributed to storage, contributing to reduced fuel consumption and improved effective runtime in representative operating conditions.

The system supports modular scalability, allowing additional energy storage modules (430, 440) or power conversion components to be added to meet site-specific requirements. This modularity enables deployment across a range of telecommunications installations without redesigning the underlying system architecture.

The embodiment further supports rapid deployment and integration with existing tower infrastructure. The system interfaces with standard AC and DC power connections used in telecommunications equipment, allowing straightforward installation and commissioning. In some embodiments, the system may be deployed as a retrofit solution alongside existing backup power equipment.

### 4A.3 Runtime and Deployment Considerations

The system is particularly well suited for remote telecommunications tower installations in which grid power is unavailable, intermittent, or unreliable. The alternating energy storage architecture allows efficient operation during extended outages while maintaining continuous service to critical communications equipment.

The supervisory controller (300) may adjust operating parameters based on site-specific factors including load profiles, environmental conditions, and maintenance schedules. In some embodiments, remote monitoring and control capabilities may be provided to enable centralized management of multiple deployed systems.

This cell tower embodiment illustrates application of the unified architecture described herein to a specific deployment environment while preserving the fundamental operating principles of the invention. The same supervisory control framework (300), alternating energy storage strategy, and feedback-driven coordination described in Sections 4.1-4.3 are employed to provide reliable and efficient power for telecommunications infrastructure.

### 4.B Data Center Embodiment

### 4B.1 Overview

In another embodiment, the invention functions as a power control and surge-absorption system for data centers. This embodiment is applicable to enterprise computing facilities, cloud computing installations, edge compute nodes, and colocation environments in which electrical demand is highly dynamic and may change rapidly when computational workloads begin, shift, or migrate. In representative deployments, one or more systems as described herein are installed upstream of the data center load center, as implemented within a representative data center electrical architecture. The invention may be deployed in parallel with existing uninterruptible power supplies, battery banks, and utility feeds.

A distinguishing feature of this embodiment is the ability to provide a stable source of electrical power while absorbing extremely rapid surge events that would otherwise destabilize upstream utility connections or overload conventional infrastructure. Following such surge events, the system returns autonomously to steady-state operation without requiring excessive generator cycling, manual intervention, or prolonged recovery intervals.

### 4B.2 Surge Events in Data Centers

Modern data centers routinely experience surge events arising from machine learning model training and inference initialization, GPU or TPU hot starts, network rebalancing operations, storage array synchronization, emergency workload migration under container orchestration, and thermal transients associated with HVAC ramping. These surge events may occur over timescales ranging from sub-second intervals to multiple minutes. In common operating scenarios, surge demand may exceed nominal steady-state load by approximately thirty to forty percent, and in peak scenarios may exceed nominal load by sixty percent or more.

Traditional approaches to handling such surge behavior rely on oversized uninterruptible power supplies and large diesel generators. These approaches are capital-intensive, inefficient under partial loading, and slow to respond to fast-changing load conditions. By contrast, the alternating discharge architecture of the present invention, together with the controlled feedback distribution path, absorbs surge demand dynamically without requiring oversized generation capacity or large dedicated UPS installations.

### 4B.3 System Placement and Electrical Integration

In this embodiment, the invention may be integrated either in series upstream of the data center load center or in parallel as a supplemental power source supplying a shared electrical bus. Electrical integration typically includes a connection between AC BUS #1 and the data center load, as well as a connection between AC BUS #2 and either an on-site generator, a utility feed, or both. Automatic transfer switches and redundant feeder arrangements may be employed to ensure continuity of service.

### 4B.4 Energy Absorption Behavior

When a surge event occurs, such as the startup of a machine learning cluster or a large-scale memory synchronization operation, load demand may increase abruptly. In response, the active energy storage module immediately supplies surge power through its discharge pathway, without perceptible delay. Concurrently, the generator increases output under controlled excitation and speed regulation to maintain stability of AC BUS #1.

As the surge subsides, generator output that would otherwise be dissipated or throttled is partially recaptured through the feedback distribution path and returned to the inactive storage module. This interaction produces a damped surge response characterized by reduced peak excursion and shortened transient duration. Surge power remains within a closed operating boundary, enabling a supervisory power-control platform capable of absorbing surge events in data center environment without requiring large battery installations or oversized generators. Once the transient has passed, alternation between storage modules resumes, and both modules continue operation within their bounded state-of-charge envelopes.

### 4B.5 Post-Surge Recovery

Following completion of a surge event, generator output stabilizes and the system returns automatically to its alternating discharge and recharge pattern. State-of-charge envelopes for the energy storage modules are restored without manual intervention, and the system continues steady-state operation. In certain embodiments, supervisory platforms may coordinate multiple deployed units across a campus or geographic area to optimize post-surge recovery and load sharing. This autonomous recovery behavior represents a significant advantage over conventional systems that require operator intervention or extended recovery periods following transient road conditions.

### 4B.6 Tertiary Storage in Data Center Applications

In many data center deployments, tertiary storage is optional or minimal because upstream utility systems, uninterruptible power supplies, or existing battery banks already provide some degree of surge buffering. However, tertiary storage may be included where extended runtime is required during upstream outages or where maintenance windows demand uninterrupted power delivery. In such cases, tertiary storage may be sized to provide runtime on the order of minutes, hours, or days, depending on applicable service-level agreements.

Integration of tertiary storage does not alter the alternating discharge architecture and may be coordinated by the supervisory control system in the same manner as generators or renewable sources.

### 4B.7 Supervisory Role in Data Center Environment

A key inventive feature of this embodiment is the ability of the system to function as the supervisory control platform for the entire power domain. The invention may coordinate utility feeds, on-site generation assets, uninterruptible power supplies, flywheels, battery banks, and cooling systems. The Intelligent Control System described previously may regulate generator excitation, coordinate switching events, smooth bus frequency, enforce state-of-charge envelopes, shed or reallocate load, and provide telemetry to cloud-based monitoring platforms.

In many deployments, the invention forms the central power coordination point through which all energy flow is managed. This supervisory role extends beyond simple power provision, integrating alternating energy storage, feedback distribution, and constraint-based switching logic to produce unexpected stability and efficiency in high-surge computing environments.

### 4B.8 Scaling in Data Center Contexts

Multiple systems may be deployed in parallel, in N+1 configurations, or in redundant ring architecture spanning a data center campus. Coordination among systems may be achieved through shared telemetry buses or cloud-based orchestration platforms. Such coordination enables peak-load shaving, rolling surge response, geographic fault isolation, and support for live workload migration without power disruption. Scaling preserves the alternating discharge architecture while enhancing resiliency through distributed placement.

### 4B.9 Benefits of the Data Center Embodiment

This embodiment provides smooth handling of surge loads, reduction in generator sizing requirements, reduction in uninterruptible power supply footprint, increased operational efficiency, and continuous uptime without brownouts. The system enables rapid deployment, modular scaling, and reduced infrastructure capital expenditure. The closed-loop feedback architecture yields unexpected advantages in burst-driven, GPU-driven, and continuously migrating workloads. Resilience is achieved without overprovisioning, and steady-state operation resumes autonomously.

### 4.C EV Charging and Distributed Energy Services Embodiment

In another embodiment, the invention is deployed as a distributed energy system to support electric vehicle (EV) charging infrastructure. This embodiment is applicable to locations in which EV charging demand is intermittent, grid access is limited or costly, or rapid charging creates substantial peak demand. In these contexts, the system supplies baseline electrical power while also absorbing and supplying rapid surge power during charging events.

The system may be deployed in grid-connected, hybrid, or off-grid configurations. In representative embodiments, renewable energy sources are electrically coupled to a secondary electrical bus (220) or through DC-DC conversion stages to charge one or more energy storage modules (430, 440). The feedback distribution path (900) remains operative such that surplus renewable energy, generator output, or recovered energy may be returned to storage, directed to tertiary storage (500) where present, or exported to the grid where permitted.

The closed-loop alternating energy storage architecture enables rapid deployment, modular scaling, and reduced infrastructure capital cost. The system autonomously returns to steady-state operation following charging surge events, without requiring overprovisioning of upstream grid capacity or generation assets.

### 4C.2 Charging Demand Characteristics

EV charging environments frequently exhibit burst-driven demand profiles, including abrupt initiation and termination of charging sessions, high-power fast charging events, and clustered charging behavior. Such demand profiles may arise in public fast-charging installations, fleet depots, shared-mobility hubs, or commercial facilities serving multiple vehicles.

In representative operating scenarios, charging demand may increase rapidly as vehicles are connected and charging ramps to rated power. Traditional infrastructure designed to support these patterns often requires oversized transformers, upgraded utility interconnections, or acceptance of high demand charges. By contrast, the alternating discharge architecture of the present invention absorbs charging surges dynamically using stored energy within the energy storage modules (430, 440), thereby reducing reliance on oversized grid connections or generation assets.

### 4C.3 Operational Behavior During Charging Events

During a charging event, an active energy storage module (430 or 440) supplies surge power through its discharge pathway via an inverter (250) to support rapid charging ramp-up. Concurrently, the motor-generator assembly (230) may operate to maintain voltage and frequency stability on the electrical bus (210) and to replenish storage during lower-demand intervals.

As charging demand tapers or vehicles disconnect, generator output and available system power that would otherwise be curtailed may be partially recaptured through the feedback distribution path (900) and returned to the inactive energy storage module. This interaction maintains bounded state-of-charge envelopes for the energy storage modules and reduces generator cycling, thermal stress, and storage degradation.

Once charging events conclude, the system resumes steady-state alternating discharge and recharge operation under supervisory control (300). 4C.4 Fleet and Commercial Charging Applications

In commercial deployments, the invention may be used to support fleet-based EV charging operations including rental car fleets, delivery vehicle fleets, municipal bus depots, logistics hubs, and rideshare or shared-mobility facilities. In such environments, charging behavior often follows predictable temporal patterns such as overnight bulk charging, scheduled downtime between shifts, or concentrated charging activity during dispatch or turnaround periods.

These fleet-based charging profiles frequently include periods of sustained charging demand interspersed with short-duration, high-power fast-charging events. The alternating energy storage architecture enables such charging profiles to be supported using reduced grid capacity and smaller generator installations, while still accommodating rapid charging events when required.

During fleet charging operations, the supervisory controller (300) coordinates discharge and recharge of the energy storage modules (430, 440) to supply surge power during vehicle plug-in and ramp-up, while managing generator engagement and feedback distribution to restore state-of-charge during lower-demand intervals.

### 4C.5 Supervisory Control and Integration

The Intelligent Control System (300) may optimize EV charging operations by coordinating charging schedules, enforcing state-of-charge constraints across multiple energy storage modules, and aligning generator operation with predictable charging windows. In some embodiments, the system may interface with fleet management software, dispatch systems, billing platforms, or energy management systems to support accounting, reporting, or allocation of energy usage across vehicles or operators.

The system may operate autonomously or under supervisory oversight, adapting to real-time charging demand, generator availability, renewable input, and environmental conditions. Integration of renewable energy sources and optional tertiary storage (500) further reduces operating costs and improves resilience in representative deployments.

### 4C.6 Deployment Considerations

In municipal or commercial transit environments such as bus depots or delivery centers, the invention enables deployment of charging infrastructure without requiring major utility upgrades. The system may be installed as a containerized or cabinet-based unit (100) proximate to charging equipment, and may operate in grid-connected, hybrid, or off-grid modes depending on site conditions.

The alternating discharge architecture improves generator sizing efficiency, reduces maintenance intervals, and extends energy storage module lifespan. These characteristics are particularly advantageous in EV charging environments characterized by repetitive, high-intensity charging cycles and burst-driven demand behavior.

### 4.D Microgrid Embodiment (Islanded, Weak Grid and Dropout Operation)

In another embodiment, the invention is deployed as a microgrid system configured for islanded operation, weak-grid environments, and conditions characterized by intermittent grid availability or complete grid dropout. In this embodiment, the system operates as a localized generation, storage, and control asset capable of sustaining electrical service independently of a centralized utility grid.

The microgrid may be implemented at a small commercial campus, an industrial or institutional facility, a military installation, a rural or remote community, or other locations where grid reliability is limited, unavailable, or economically impractical.

The microgrid embodiment integrates one or more local power generation sources with energy storage modules under supervisory control to establish a self-contained electrical network. Local generation may include renewable sources, including but not limited to solar photovoltaic arrays, wind generation, or other distributed energy resources, as well as conventional generation where appropriate. The energy storage modules operate in coordination with the generation assets to buffer generation variability, absorb excess energy, and supply power during periods of insufficient generation or grid interruption.

The system is configured to support transitions between grid-connected operation and islanded operation. In regions where the utility grid is weak, unreliable, or subject to frequent disturbances, the system dynamically regulates power flow to maintain voltage and frequency stability without reliance on external infrastructure. During grid dropout events, the system continues autonomous operation, supplying loads according to predefined priority schemes while maintaining bounded state-of-charge operation of the energy storage modules.

In this embodiment, a closed-loop feedback architecture governs interactions among generation, storage, and load demand within the microgrid. Feedback control enables rapid response to transient load changes, intermittent renewable generation, and sudden loss or restoration of grid connection. A supervisory controller manages charge and discharge cycles of the storage modules to prevent over-discharge, over-charge, or instability during sustained islanded operation or repeated transition events.

The microgrid embodiment further enables distributed charging and power delivery in environments where traditional electrical infrastructure would otherwise be unavailable or uneconomical. By combining localized generation with energy storage and feedback-controlled distribution, the system provides electrical service in regions lacking sufficient transmission capacity or where infrastructure deployment costs are prohibitive. This capability supports fixed loads as well as variable or mobile loads within the microgrid boundary.

Integration with renewable energy sources is a core aspect of this embodiment. Renewable generation may be incorporated directly into the microgrid architecture, with surplus energy absorbed by the storage modules and dispatched as needed to maintain continuous operation. Where renewable output exceeds immediate demand, the system regulates storage charging to maintain bounded operating conditions while preserving energy availability for later use. Where renewable output is insufficient, stored energy is released to support load continuity.

The system may further support commercial billing and energy accounting within the microgrid. In deployments serving multiple users, tenants, or facilities, the system may track energy production, storage utilization, and consumption at defined points within the microgrid. This enables allocation of energy costs, usage-based billing, and internal settlement without reliance on external metering infrastructure. Such accounting functions may operate during both grid-connected and islanded modes.

In weak-grid or dropout environments, the system provides resilience through sustained operation during prolonged outages and rapid stabilization following grid disturbances. The microgrid architecture reduces dependence on oversized backup generators by leveraging coordinated storage operation and feedback-controlled power flow. As a result, generator sizing requirements may be reduced while maintaining continuous service and operational reliability.

The microgrid embodiment further supports deployment in regions where electrical demand varies significantly over time. The system absorbs rapid load changes and intermittent demand without destabilizing the network, enabling reliable operation in environments subject to fluctuating usage patterns, including rural, remote, or infrastructure-constrained locations.

Collectively, the microgrid embodiment provides operational resilience, efficient utilization of local generation, integration of renewable resources, and sustained electrical service in islanded, weak-grid, and dropout conditions. By combining closed-loop feedback control, bounded energy storage operation, and localized generation, the system delivers reliable power in environments where conventional grid solutions are unavailable, unreliable, or economically impractical.

It will be appreciated that the embodiments described herein are illustrative and not limiting. The systems, methods, and architectures disclosed may be implemented in various combinations, configurations, and scales without departing from the spirit and scope of the invention. Features described in connection with one embodiment may be combined with features of other embodiments where appropriate, even if such combinations are not expressly illustrated.

The invention may be implemented using hardware, firmware, software, or any combination thereof. Control functions described herein may be executed by one or more processors, controllers, or computing elements operating under stored instructions, real-time logic, or distributed supervisory control. Functional blocks described as discrete components may be integrated, subdivided, or distributed across multiple physical or logical elements depending on the deployment environment and performance requirements.

Operational parameters, including power ratings, storage capacities, timing thresholds, and control responses, may be selected or adjusted based on application-specific constraints, regulatory requirements, environmental conditions, or system objectives. Such parameters are provided by way of example and do not limit the invention to any particular numeric values or operating ranges unless explicitly claimed.

While the invention has been described in the context of power generation, storage, and distribution systems, the principles disclosed herein are applicable to a wide range of electrical and energy-management environments. The described architectures are intended to enhance reliability, resilience, efficiency, and controllability across varied use cases, including grid-connected, weak-grid, and fully islanded operation.

Accordingly, the scope of the invention is defined by the claims and their equivalents rather than by the foregoing description. All modifications, substitutions, and variations falling within the scope of the claims are intended to be embraced thereby.

What is claimed as the invention is:

1. A power system, comprising:
at least two energy storage modules;
at least one electrical bus configured to deliver power to a load;
a motor-generator assembly electrically coupled to the electrical bus;
a feedback distribution system (FDS) configured to route a proportion of electrical power produced by the motor-generator assembly back to at least one of the energy storage modules; and
an intelligent control system configured to:
cause a first energy storage module to discharge and supply power to the electrical bus while a second energy storage module is charged,
switch discharge and charge roles between the energy storage modules in an alternating manner, and
maintain each energy storage module within a bounded state-of-charge envelope, wherein the power system is configured to deliver stable power to the load while alternating discharge and recharge of the energy storage modules and selectively engaging the feedback distribution system to reduce effective energy loss.

2. The power system of claim 1, wherein discharge intervals are longer than recharge intervals such that the state of charge of each energy storage module oscillates within the bounded state-of-charge envelope.

3. The power system of claim 1, wherein the bounded state-of-charge envelope is defined by an upper state-of-charge limit and a lower state-of-charge limit enforced by the intelligent control system.

4. The power system of claim 1, wherein the feedback distribution system is selectively engaged by switching elements under control of the intelligent control system.

5. The power system of claim 1, wherein the feedback distribution system routes electrical energy that would otherwise be dissipated during generator operation to charge an energy storage module.

6. The power system of claim 1, wherein the motor-generator assembly converts electrical energy to mechanical energy and back to electrical energy to maintain voltage and frequency on the electrical bus.

7. The power system of claim 1, further comprising at least two electrical buses, including a first electrical bus supplying power to the load and a second electrical bus associated with charging and generator pathways.

8. The power system of claim 1, wherein the intelligent control system monitors at least one of state of charge, voltage, current, temperature, generator output, or load demand.

9. The power system of claim 1, wherein switching between discharge and recharge occurs without interruption of stable power delivered to the load.

10. A method of supplying electrical power, comprising:
discharging a first energy storage module to supply power to an electrical bus and a load;
charging a second energy storage module while the first energy storage module is discharging;
generating electrical power using a motor-generator assembly coupled to the electrical bus;
routing, via a feedback distribution system (FDS), a proportion of generated electrical power back to at least one energy storage module;
monitoring a state of charge of each energy storage module; and
alternately switching discharge and recharge roles between the energy storage modules to maintain each energy storage module within a bounded state-of-charge envelope while supplying stable power to the load.

11. The method of claim 10, wherein discharge durations exceed recharge durations to prevent convergence of the energy storage modules toward depletion.

12. The method of claim 10, further comprising selectively engaging or bypassing the feedback distribution system based on operating conditions.

13. The method of claim 10, wherein the method is performed under supervisory control that enforces safety constraints and maintains stable power delivery.

14. The power system of claim 1, wherein the power system is configured as a primary or backup power source for a telecommunications cell tower.

15. The power system of claim 14, wherein the power system is configured to deliver alternating current power to telecommunications equipment associated with the cell tower.

16. The power system of claim 14, wherein the power system is configured to supply electrical power in a range of approximately 15 kilowatts to approximately 30 kilowatts.

17. The power system of claim 14, wherein the power system is deployed within a transportable enclosure positioned proximate to the telecommunications cell tower.

18. The power system of claim 14, wherein the intelligent control system is configured to accommodate variable load demand associated with transmission, idle, and peak communication periods of the telecommunications cell tower.

19. The power system of claim 14, wherein the feedback distribution system is selectively engaged to reduce fuel consumption or generator runtime during partial-load operation of the telecommunications cell tower.

20. The method of claim 10, wherein the method is performed to supply electrical power to a telecommunications cell tower.

21. The method of claim 20, wherein supplying electrical power comprises delivering alternating current power to telecommunications transmission equipment.

22. The method of claim 20, wherein the method supplies electrical power in a range of approximately 15 kilowatts to approximately 30 kilowatts.

23. The method of claim 20, wherein the method is performed using a power system deployed within a transportable enclosure located proximate to the telecommunications cell tower.

24. The method of claim 20, wherein the method further comprises accommodating variable load demand associated with transmission peaks and idle periods of the telecommunications cell tower while maintaining bounded state-of-charge operation of the energy storage modules.

25. The method of claim 20, wherein selectively engaging the feedback distribution system reduces generator runtime or fuel consumption during operation of the telecommunications cell tower.
